(19) United States
(12) Patent Application Publication
(10) Pub. No.: US 2010/0224704 A1
(43) Pub. Date: Sep. 9, 2010

(54) SHOWERHEAD

(75) Inventor: Kazuo Miwa, Tokyo (JP)

Correspondence Address: BUCHANAN, INGERSOLL & ROONEY PC, POST OFFICE BOX 1404, ALEXANDRIA, VA, 22313-1404, US

(73) Assignee: Technomirai Co., Ltd., Shinjuku-ku (JP)

(21) Appl. No.: 12/092,737

(22) PCT Filed: Aug. 24, 2007
(86) PCT No.: PCT/JP2007/066448

§ 371 Date: May 6, 2008

(51) Int. Cl. A62C 37/20

(52) U.S. Cl. 239/562

(57) ABSTRACT

[Object] A showerhead in which clean water is supplied into a space in a head main body whose upper end is closed with an upper water-discharge plate through a main water port, and the clean water is discharged through a plurality of shower water-discharge holes formed in the upper water-discharge plate. It is possible to discharge clean water under a preferable water pressure and with a preferable water force irrespective whether a water pressure of clean water to be supplied is high or low.

[Solving Means] The space is divided by a parting plate having at least one or more communication holes into a feedwater-side space formed on the side of the upper water-discharge plate and a discharge-side space formed on the side of the main water port, an adjusting plate has adjusting holes at locations corresponding to the communication holes formed in the parting plate, the adjusting plate is slidably disposed on the parting plate on the side of the feedwater-side space, the discharge-side space and the feedwater-side space are in communication with each other through the communication holes formed in the parting plate and the adjusting holes formed in the adjusting plate at location corresponding to the communication holes of the parting plate, and a total cross-sectional area through which the clean water passes from the feedwater-side space to the discharge-side space through the communication holes is adjusted by sliding the adjusting plate on a surface of the parting plate on the side of the feedwater-side space.

### TECHNICAL FIELD

The present invention relates to a showerhead, and more particularly, to a water-saving type showerhead which can discharge water under desired pressure and with desired force, and capable of saving water.

### BACKGROUND ART

There are conventional proposed various showerhead, especially water-saving type showerhead capable of saving water without lowering water force (e.g., Japanese Patent Application Laid-open No. 8-266940).

One example of a general structure of the showerhead will be explained with reference to FIGS. 1(a) to (c).

Hot water or water is supplied into a head main body 2 through a main water port 1 in a direction of the arrow 8. In the specification and claims, hot water or water which is supplied to the head main body 2 through the main water port 1 is called “clean water”.

The head main body 2 has a space 3 therein as show in FIGS. 1(b) and (c). The upper side, right side in FIG. 1(b), and the upper side in FIG. 1(c) of the space 3 are closed with an upper water-discharge plate 4. In the illustrated embodiment, a fixed portion 6 is formed in the head main body 2. The upper water-discharge plate 4 is fitted and fixed to an upper portion of the head main body 2 by threadedly engaging a screw 7 to the fixed portion 6 at a central portion of the upper water-discharge plate 4, and an upper side of the space 3 is closed with the upper water-discharge plate 4.

The upper water-discharge plate 4 has a plurality of shower water-discharge holes 5 as shown in FIG. 1(a). In the illustrated embodiment, 71 shower water-discharge holes 5 are formed concentrically.

When a showerhead is used, clean water is supplied to the head main body 2 through the main water port 1 in the direction of the arrow 8. The supplied clean water is discharged powerfully through the space 3 and the plurality of shower water-discharge holes 5 formed in and the upper water-discharge plate 4.

In the case of such a conventional showerhead, there is a problem that too much clean water more than necessary is discharged from the shower water-discharge holes 5.

Especially when the water pressure is strong, too much clean water more than necessary is discharged, and this state continues every day, and 365 days a year. Thus, there is a problem that the usage of clean water is increased, and the water charge is increased.

For example, in a region where a water pressure is high, or when a shower is used on a low floor in a high-rise hotel or condominium, the usage of clean water is increased and the water charge is increased as described above.

Even if the water pressure is not high, if the frequency of usage of shower is high or installation scale of showers is great in a house, a condominium, a dormitory, a sports facility, a beauty salon and the like, even if the amount of clean water to be used is slightly excessive, such excessive amount is accumulated for a long term, such amount will become great cost.

In a region where the water pressure is low, the water pressure and the amount of water has a direct relation. Therefore, the force of clean water discharged from the shower water-discharge holes 5 is weak, people who use the showers use more clean water so as to cover the weak water force. Thus, there is a problem that the usage of clean water is increased.

Such a phenomenon that the water pressure is low and the usage of clean water is increased occurs when a shower is used in a region where the water pressure is low, or in a high-rise hotel or condominium.

The same problem also occurs when many people using the same water supply pipe use the showers at the same time in a hotel or condominium having a large floor-space. In a house, a condominium, a dormitory, a sports facility, a beauty salon and the like, the water pressure becomes lower according to time and circumstances, and there is a problem that if the user try to cover the weak water pressure, the usage of water is increased.

To solve such problems, there is proposed a showerhead in which a parting plate is disposed in the space 3 of the head main body 2 in parallel to the upper water-discharge plate 4. With this, the capacity of the space 3 of the head main body 2 is divided into two, and the water pressure is adjusted by adjusting the capacities of the space which is divided into two. Further, the size of holes formed in the parting plate, the size and the number of shower water-discharge holes 5 formed in the upper water-discharge plate 4 are adjusted to save water without lowering the water force of water.

Patent Document 1: Japanese Patent Application Laid-open No, 8-266940

### DISCLOSURE OF THE INVENTION

### Problem to be Solved by the Invention

In the case of the conventional showerhead, there is a problem that the usage of clean water is increased irrespective of whether the water pressure is high or low.

Even with the showerhead in which the parting plate is disposed in the space of the head main body in parallel to the upper water-discharge plate, the problem that the usage of clean water is increased more than necessary can not be solved sufficiently.

If the water force of clean water discharged from the water-discharge holes is too strong, a user of the shower feels a pain in his or her skin, and if the water force is too weak, the user can not feel excellent using feeling, and shampoo can not be rinsed well, and the user feels uncomfortable.

It is an object of the present invention to improve the showerhead in which a parting plate is disposed in the space of the head main body in parallel to the upper water-discharge plate, and to provide a showerhead capable of discharging water under a preferable water pressure and with preferable water force and capable of saving water even if the water pressure of clean water supplied to the showerhead is high or low.

### Means for Solving the Problems

To achieve the above object, a showerhead in which clean water is supplied into a space in a head main body whose upper end is closed with an upper water-discharge plate through a main water port, and the clean water is discharged through a plurality of shower water-discharge holes formed in the upper water-discharge plate has the following features.

First, the space is divided by a parting plate having at least one or more communication holes into a feedwater-side space formed on the side of the upper water-discharge plate and a discharge-side space formed on the side of the main water port

An adjusting plate has adjusting holes at locations corresponding to the communication holes formed in the parting plate, the adjusting plate is slidably disposed on the parting plate on the side of the feedwater-side space, and the discharge-side space and the feedwater-side space are in communication with each other through the communication holes formed in the parting plate and the adjusting holes formed in the adjusting plate at location corresponding to the communication holes of the parting plate.

A total cross-sectional area through which the clean water passes from the feedwater-side space to the discharge-side space through the communication holes is adjusted by sliding the adjusting plate on a surface of the parting plate on the side of the feedwater-side space.

In the showerhead of the present invention, the adjusting plate always receives a biasing force in a direction increasing or reducing the total cross-sectional area through which the clean water passes from the feedwater-side space to the discharge-side space through the communication holes, the adjusting plate includes a water amount adjusting piece disposed in a direction intersecting with a flow of the clean water supplied to the space in the head main body through the main water port, and the adjusting plate slides in a direction reducing or increasing the total cross-sectional area through which the clean water passes.

In the above-explained showerhead of the invention also, a capacity of the feedwater-side space is two to three times greater than a capacity of the discharge-side space, and when the total cross-sectional area through which the clean water of the main water port passes is defined as a total cross-sectional area of a portion from the feedwater-side space to the discharge-side space through which the clean water passes is in a range of 38 to 44, and a total cross-sectional area of the shower water-discharge holes through which the clean water passes is in a range of 12 to 16.

### EFFECT OF THE INVENTION

According to the present invention, it is possible to improve the showerhead in which a parting plate is disposed in the space of the head main body in parallel to the upper water-discharge plate, and to provide a showerhead capable of discharging water under a preferable water pressure and with preferable water force and capable of saving water even if the water pressure of clean water supplied to the showerhead is high or low.

### BEST MODE FOR CARRYING OUT THE INVENTION

A preferred embodiment of the present invention will be explained with reference to the accompanying drawings.

FIGS. 2(a) to 6(c) are explanatory diagrams of the preferred embodiment of a showerhead of the present invention. The same elements as those of the conventional showerhead structure explained using FIGS. 1(a) to 1(c) are designated with the same symbols, and explanation thereof will be omitted.

According to the showerhead of the invention shown in FIGS. 2(a) to 6(b), like the conventional showerhead shown in FIGS. 1(a) to 1(c), the showerhead is provided therein with a space, and an upper end of the space of a head main body 2 is closed with an upper water-discharge plate 4, water is supplied to the space through a main water port 1, and the water is discharged through a plurality of shower water-discharge holes 5 formed in the upper water-discharge plate 4.

In the showerhead of the invention, the space formed in the showerhead is divided into a discharge-side space 13b and a feedwater-side space 13a.

The discharge-side space 13b is formed on the side of the upper water-discharge plate 4 as shown in FIGS. 3(a) and (b).

The feedwater-side space 13a is formed on the side of the main water port 1 as shown in FIGS. 3(a) and (b).

The discharge-side space 13b and the feedwater-side space 13a are in communication with each other through communication holes formed in a parting plate 11. At least one or more communication holes are formed in the parting plate 11. In the illustrated embodiment, as shown in FIG. 2(b), the discharge-side space 13b and the feedwater-side space 13a are in communication with each other through two communication holes 12a and 12b.

In the illustrated embodiment, a central portion 11a of the parting plate 11 is provided at its central portion with a hole through which a screw 7 passes. The central portion 11a is placed on a fixed portion 6, the upper water-discharge plate 4 is placed on the fixed portion 6 through a packing 15, and the upper water-discharge plate 4 is fastened and fixed to the fixed portion 6 by means of the screw 7. With this, the parting plate 11 is fixed onto the fixed portion 6, and the upper water-discharge plate 4 is fitted and fixed to the upper side of the discharge-side space 13b of the head main body 2.

The upper end side of the space in the head main body 2 is closed with the upper water-discharge plate 4, and the space in the head main body 2 is divided into the discharge-side space 13b and the feedwater-side space 13a by the parting plate 11.

In the showerhead of the invention, an adjusting plate 21 is slidably disposed on the side of the feedwater-side space 13a of the parting plate 11.

The adjusting plate 21 has adjusting holes 22a and 22b at locations corresponding to the communication holes 12a and 12b formed in the parting plate 11.

In the illustrated embodiment, since the parting plate 11 includes two communication holes 12a and 12b, the adjusting plate 21 also includes the two adjusting holes 22a and 22h at locations corresponding to the communication holes 12a and 12b formed in the parting plate 11. In the illustrated embodiment, the size of the adjusting hole 22a is the same as that the communication hole 12a, and the size of the adjusting hole 22b is the same as that the communication hole 12b.

The illustrated embodiment also includes guide grooves 26a, 26b and 26c in addition to the adjusting holes 22a and 22b. The parting plate 11 includes guide projections 16a, 16b and 16c on the side (left side in FIG. 4(a)) of the feedwater-side space 13a.

The adjusting holes 22a and 22b are associated with the positions of the communication holes 12a and 12b, the guide projections 16a, 16b and 16c of the parting plate 11 are press-fitted into the guide grooves 26a, 26b and 26c of the adjusting plate 21 to establish the states shown in FIGS. 5(a) and 5(b), and the adjusting plate 21 is slidably disposed on the parting plate 11 on the side of the feedwater-side space 13a

With this, as shown in FIGS. 4(a) and 5(b), the discharge-side space 13b and the feedwater-side space 13a are communication with each other through the communication holes 12a formed in the parting plate 11 and the adjusting hole 22a formed at the location corresponding to the communication holes 12a formed in the parting plate 11 in the adjusting plate 21. The discharge-side space 13b and the feedwater-side space 13a are in communication with each other through the communication holes 12b formed in the parting plate 11 and the adjusting hole 22b formed at the location corresponding to the communication holes 12b of the parting plate 11 in the adjusting plate 21

By sliding the adjusting plate 21 on the surface of the parting plate 11 on the side of the feedwater-side space 13a, the total cross-sectional area of portions through which clean water passes from the feedwater-side space 13a toward the discharge-side space 13h through the communication holes 12a and 12b is adjusted.

For example, if the adjusting plate 21 rotates around the fixed portion 6 in the direction shown with the arrow 31 in FIG. 6(a), the discharge-side space 13b and the feedwater-side space 13a are brought into communication with each other at a location shown with a symbol 32a in FIGS. 6(a) and (c) and a location shown with a symbol 32b in FIG. 6(a).

That is, the adjusting plate 21 rotates around the fixed portion 6 in the direction shown with the arrow 31 from the state shown in FIG. 5(a) to assume the state shown in FIG. 6(a). With this, the total cross-sectional area through which clean water passes from the feedwater-side space 13a to the discharge-side space 13b through the communication holes 12a and 12b becomes smaller than that in the state shown in FIG. 5(a).

On the other hand, if the adjusting plate 21 rotates around the fixed portion 6 in the direction shown with the arrow 25 in FIG. 6(a) from the state shown in FIG. 6(a) to assume the state shown in FIG. 5(a), the discharge-side space 13b and the feedwater-side space 13a are brought into communication with each other at locations shown with symbols 12a and 22a and at locations shown with symbols 12b and 22b shown in FIG. 5(a).

That is, the adjusting plate 21 rotates around the fixed portion 6 in the direction shown with the arrow 25 to assume the state shown in FIG. 5(a). With this, the total cross-sectional area through which clean water passes from the feedwater-side space 13a to the discharge-side space 13h through the communication holes 12a and 12b becomes greater than that in the state shown in FIG. 6(a).

This will be explained in more detail with reference to FIGS. 5(a), 6(a) to 6(c).

In the state shown in FIG. 5(a), the size of the communication holes 12a is the same as that of the adjusting hole 22a. Therefore, clean water passes through the holes of sizes shown with symbols 12a and 22a in FIG. 6(b) from the feedwater-side space 13a to the discharge-side space 13b.

On the other hand, if the adjusting plate 21 rotates around the fixed portion 6 in the direction shown with the arrow 31 to assume the state shown in FIG. 6(a), since the position of the communication holes 12a is not varied, the adjusting hole 22a moves into the direction of the arrow 31 as shown in FIG. 6(c), and clean water passes through the hole of size shown with the symbol 32a in FIG. 6(c) from the feedwater-side space 13a to the discharge-side space 13b.

If the adjusting plate 21 rotates around the fixed portion 6 in the direction shown with the arrow 25 to return to the state shown in FIG. 5(a), the adjusting plate 21 assumes the state shown in FIG. 6(b), the total cross-sectional area of the portion through which clean water passes from the feedwater-side space 13a to the discharge-side space 13b through the communication hole 12a becomes greater than that in the state shown in FIGS. 6(a) and 6(c).

In the showerhead of the present invention, the adjusting plate 21 always receives a biasing force in a direction increasing or reducing the total cross-sectional area through which clean water passes from the feedwater-side space 13a to the discharge-side space 13b through the communication holes 12a and 12b.

In the illustrated embodiment, a spring 29 is stretched between a projection 23a projecting from the adjusting plate 21 toward the feedwater-side space 13a and a projection projecting from the parting plate 11 toward the feedwater-side space 13a. With this, the projection 23a projecting from the adjusting plate 21 toward the feedwater-side space 13a is always biased in the direction shown with the arrow 24 (FIGS. 5(a) and 6(a)), and the adjusting plate 21 always receives a biasing force in the direction with the arrow 25 (FIGS. 5(a) and 6(a)).

In the illustrated embodiment, in a range where the water pressure of clean water supplied from the main water port 1 in the direction of the arrow 8 does not exceed a predetermined water pressure, the adjusting plate 21 always receives a biasing force in the direction of the arrow 25 (FIGS. 5(a) and 6(a)) by the tension of the spring 29, and the state shown in FIG. 5(a) is maintained. That is, the adjusting plate 21 always receives the biasing force in the direction in which the total cross-sectional area through which clean water passes from the feedwater-side space 13a to the discharge-side space 13b through the communication holes 12a and 12b is increased.

This is realized by appropriately adjusting disposition and the sizes of the guide projections 16a, 16b and 16c, the guide grooves 26a, 26b and 26c, the communication holes 12a and 12b, and the adjusting holes 22a and 22b, and tension of the spring 29.

In the showerhead of the invention, the adjusting plate 21 includes a water amount adjusting piece 20 (FIGS. 5(a) and 6(a)) disposed in a direction intersecting with a flowing direction of clean water supplied to the space of the head main body 2 through the main water port 1 in the direction of the arrow 8.

The adjusting plate 21 slides in a direction increasing or reducing the total cross-sectional area through which clean water passes from the feedwater-side space 13a to the discharge-side space 13b through the communication holes 12a and 12b against the biasing force in accordance with the water pressure of clean water which abuts against the water amount adjusting piece 20.

In the illustrated embodiment, as shown in FIGS. 5(a), 5(c) and 6(a), the water amount adjusting piece 20 is disposed such that it intersects with the direction of flow of clean water shown with the arrow 8 on the surface of the feedwater-side space 13a of the adjusting plate 21 and on the side facing the main water port 1.

Since the water amount adjusting piece 20 is disposed such that it intersects with the direction of flow of clean water shown with the arrow 8, the adjusting plate 21 rotates around the fixed portion 6 in the direction of the arrow 31 against the biasing force of the spring 29 in the direction of the arrow 25 in accordance with the water pressure of clean water which abuts against the water amount adjusting piece 20 from the direction of the arrow 8.

With this, in the illustrated embodiment, in accordance with the water pressure of clean water which abuts against the water amount adjusting piece 20, the adjusting plate 21 moves in a direction (direction of the arrow 31 in FIG. 6(a)) increasing or reducing the total cross-sectional area through which clean water passes from the feedwater-side space 13a to the discharge-side space 13b through the communication holes 12a and 12b against the biasing force of the spring 29 in the direction of the arrow 25.

That is, since the water amount adjusting piece 20 is disposed such that it intersects with the direction of flow of clean water supplied to the space of the head main body through the main water port 1 as shown in FIG. 6(a), clean water supplied to the main water port 1 in the direction of the arrow 8 changes its flowing direction to a direction shown with the arrow 30 in FIG. 6(a) and flows into the feedwater-side space 13a.

Hence, if the water pressure of clean water shown in the direction of the arrow 8 from the main water port 1 exceeds a tension of the spring 29 in the direction of the arrow 24 (FIG. 5(a)), the adjusting plate 21 starts moving in the direction of the arrow 31 (FIG. 6(a)) against the biasing force in the direction of the arrow 25.

With this, the total cross-sectional area through which clean water passes from the feedwater-side space 13a to the discharge-side space 13b through the communication holes 12a and 12b is reduced from a value shown with the symbols 12a and 22a, and symbols 12b and 22b in FIG. 5(a) to a value shown with symbols 32a and 32b in FIG. 6(a).

With this, even if the water pressure from the main water port 1 is increased, if the tension of the spring 29 is set to a predetermined value, clean water is supplied into the discharge-side space 13b from the feedwater-side space 13a under a desired water pressure, with desired water force, and the water amount. Then, water is discharged from the shower water-discharge holes 5 through the discharge-side space 13b under a desired water pressure and with desired water force.

With this, when a user uses the shower, the user can use the shower under preferable water pressure and with water force in accordance with a purpose of use, for example, the user can discharge water under excellent water pressure and with excellent water force for skin, and the user can discharge water under excellent water pressure and with excellent water force for washing.

In a range where the water pressure of clean water supplied from the main water port 1 in the direction of the arrow 8 does not exceed a tension of the spring 29 in the direction of the arrow 24 (FIG. 5(a)), the state shown in FIG. 5(a) is maintained. With this, clean water is supplied from the feedwater-side space 13a into the discharge-side space 13h under a desired water pressure and with a desired amount of water. Water is discharged from the shower water-discharge holes 5 through the discharge-side space 13b under a preferable water pressure and with a preferable water force.

Even after the state of the shower is brought into one shown in FIG. 6 (a), as the water pressure of clean water supplied from the main water port 1 in the direction of the arrow 8 is reduced, the water pressure is adjusted in accordance with a relation between the tension of the spring 29 and the water pressure, the adjusting plate 21 moves in the direction of the arrow 25 (FIG. 5(a)), and clean water is supplied from the feedwater-side space 13a to the discharge-side space 13b under a preferable water pressure and with a preferable water force. Water is discharged from the shower water-discharge holes 5 under a preferable water pressure and with a preferable water force through the discharge-side space 13b.

Even when clean water is supplied under a high water pressure, the total cross-sectional area through which clean water passes from the feedwater-side space 13a to the sprinkle-side space 13b through the communication holes 12a and 12b is automatically reduced from the size shown in FIG. 6(a) to a size shown in FIG. 6(a), and it is possible to always discharge water under a preferable water pressure and with a preferable water force.

On the other hand, as the water pressure is reduced from the state where the water pressure is high as shown in FIG. 6(a), the total cross-sectional area through which clean water passes from the feedwater-side space 13a to the sprinkle-side space 13b through the communication holes 12a and 12b is automatically increased from the size shown in FIG. 6(a) to the size shown in FIG. 5(a), and it is possible to always discharge water under a preferable water pressure and with a preferable water force.

With this, clean water is always supplied from the feedwater-side space 13a to the discharge-side space 13b under a preferable water pressure and with a preferable water force, water can largely be saved, satisfaction of a user of the shower can be enhanced, and it is possible to wash.

Especially when the showerhead is used in a region where a water pressure is higher, water can largely be saved, water can be discharged under a preferable water pressure and with a preferable water force, satisfaction of a user of the shower can be enhanced, and it is possible to wash.

In the showerhead of the present invention, a relation between the capacity of the feedwater-side space 13a and the capacity of the discharge-side space 13b is 1:2 to 1:3.

When the cross-sectional area through which clean water of the main water port 1 passes is defined as the total cross-sectional area through which clean water passes from the feedwater-side space 13a to the sprinkle-side space 13b through the communication holes 12a and 12b is in a range of 38 to 44, and the total cross-sectional area through which clean water of the shower water-discharge holes 5 passes is in a range of 12 to 16.

In the illustrated embodiment, the number of communication holes is two as designated with the symbols 12a and 12b, and when the cross-sectional area through which clean water of the main water port 1 passes is defined as the total cross-sectional area through which clean water of the two communication holes 12a and 12b passes is in a range of 38 to 44. The total cross-sectional area through which clean water shown with the symbols 32a and 32b in FIG. 6(a) is also in a range of 38 to 44

In the illustrated embodiment, as shown in FIG. 2(a), 30 shower water-discharge holes 5 are formed in total, i.e., sixteen shower water-discharge holes are formed on the outer side, five shower water-discharge holes are formed on the inner side, and nine shower water-discharge holes are formed therebetween. When the cross-sectional area through which clean water of the main water port 1 passes is defined as the total cross-sectional area through which clean water of the 30 shower water-discharge holes 5 passes is in a range of 12 to 16

The capacity of the feedwater-side space 13a which is directly connected to the main water port 1 is set to two or three times greater than the capacity of the discharge-side space 13b, and the total cross-sectional areas of the main water port 1, the communication holes 12a and 12b and the shower water-discharge holes 5 through which clean water passes are set to the above-described relation. With this, in a basic operation state of the showerhead of the present invention, e.g., in the state shown in FIG. 5(a), even when the water pressure of clean water shown in the direction of the arrow 8 from the main water port 1 does not exceed the tension of the spring 29 in the direction of the arrow 24 (in FIG. 5(a)), the discharge-side space 13b can be filled with clean water and water can be discharged under a preferable water pressure and with a preferable water force.

Irrespective whether the water pressure of clean water from the main water port 1 in the direction of the arrow 8 is high or low, it is possible to largely save water, satisfaction of a user of the shower can be enhanced, and it is possible to wash.

The present inventor performed experiments on a high floor and a low floor of a high-rise hotel using a showerhead of the present invention having the above-described relation between the capacity of the feedwater-side space 13a and the capacity of the discharge-side space 13b, and the above-described relation between the cross-sectional area through of the main water port 1 through which clean water passed, the total cross-sectional area of the communication holes 12a and 12b through which clean water passed and the total cross-sectional area of the shower water-discharge holes 5 through which clean water passed. As a result, water could be discharged under a preferable water pressure and with a preferable water force on both high floor and low floor, and it was confirmed that excellent satisfaction of a shower user could be obtained.

The amount of water in this case was measured, and it was possible to reduce the amount of water used by about 50% in both high floor and low floor as compared with the conventional showerhead shown in FIGS. 1(a) and (b).

(Comparison Test Example)

A showerhead of the present invention shown in FIGS. 2(a) to 6(c) having the following size was prepared.

(Tension of Spring 29)

It is generally said that a water pressure under which shower can be used comfortably is in a range of 0.2 MPa to 0.3 MPa. Hence, the employed spring 29 had such tension that when a water pressure of clean water shown in the direction of the arrow 8 from the main water port 1 exceeded 0.3 MPa, the tension overcomes the tension of the spring 29 in the direction of the arrow 24 (FIG. 5(a)).

(Capacity of the feedwater-side space 13a and capacity of the discharge-side space 13b)

The capacity of the feedwater-side space 13a was set to three times of the capacity of the discharge-side space 13b.

(Sizes of main water port 1, communication holes and shower water-discharge holes)

Main water port 1: 10φ×1, total cross-sectional area: 78.5 mm²

Communication holes 12a and 12b: two, total area: 32.1 mm²

Shower water-discharge holes 5: 0.7φ×28, total cross-sectional area: 10.8 mm²

Ratio of cross-sectional areas=cross-sectional areas of main water port and communication holes: total cross-sectional area of shower water-discharge holes=100:41:14.

As comparative example, the conventional showerhead shown in FIGS. 1(a) and (b) was used. Main water port: 10φ×1, total area: 78.5 mm², shower water-discharge holes: 0.7φ×61, and total cross-sectional area: 23.46 mm².

The showerhead of the present invention and the conventional showerhead were connected to the same water supply, the experiments were conducted, and a result shown in Table 1 was obtained.

TABLE 1

| | Conventional | | Showerhead of | |
|---|---|---|---|---|
| | showerhead | | the present invention | |
| Water pressure | 0.4 | MPa | 0.4 | MPa |
| Amount of water | 20.6 | l/min | 20.6 | l/min |
| Amount of discharged water | 17.6 | l/min | 10.6 | l/min |
| Ratio of saved water | — | | 48% | |
| Speed at outlet | 9.17 | m/s | 17.61 | m/s |
| Horizontal spray distance | 3.2 | m | 5.6 | m |

The “water pressure” and the “amount water” are “water pressure in main water port” and “amount of water of main water port”.

The “amount of discharged water” is “amount of water discharged from the shower water-discharge holes”.

The “ratio of saved water” is a value obtained by comparing amounts of water discharged from the shower water-discharge holes.

The “speed at outlet” is “speed at outlet of water discharged from the shower water-discharge holes”.

The “horizontal spray distance” is a distance of water discharged from the shower water-discharge holes in the horizontal direction.

As a result of the comparison test, according to the showerhead of the present invention, it was possible to discharge water under a preferable water pressure and with a preferable water force as shown in the results of the speed at outlet and the horizontal spray distance. The ratio of saved water was 48%, and it was confirmed that water could largely be saved as compared with the conventional showerhead, and satisfaction of a shower user could be enhanced.

Although the preferable embodiment of the present invention has been explained with reference to the accompanying drawings, the invention is not limited to the embodiment, and the invention can variously be modified within a technical range grasped from the scope of patent claims.

The mechanism for always applying a biasing force in a direction increasing or reducing the total cross-sectional area through which clean water of the communication holes 12a and 12b passes with respect to the adjusting plate 21 is not limited to the illustrated and above-mentioned mechanism, and it is possible to employ various structures and mechanisms such as one using a leaf spring structure.

The structure and mechanism in which the adjusting plate 21 is slidably disposed on the side of the feedwater-side space 13a of the parting plate 11, the mechanism in which the total cross-sectional area through which clean water of the communication holes 12a and 12h passes is adjusted by sliding the adjusting plate 21 on the surface of the parting plate 11 on the side of the feedwater-side space 13a, and the mechanism in which the adjusting plate 21 slides in a direction reducing or increasing the total cross-sectional area through which clean water of the communication holes 12a and 12b passes against the biasing force in accordance with the water pressure of clean water which abuts against the water amount adjusting piece 20 are not limited to the illustrated and above-mentioned structures, and various structures and mechanisms can be employed.

### INDUSTRIAL APPLICABILITY

Irrespective of whether the water pressure of clean water supplied into the head main body of the showerhead through the main water port is high or low, the showerhead of the present invention can discharge water under a preferable water pressure and with a preferable water force while efficiently saving water.

The showerhead of the invention can be used not only for a shower in a house, but also for showers which are used collectively at one location in large scale such as collective housing like a high-rise hotel or condominium, a swimming pool and a sports facility.

Further, the showerhead can also be used for discharging water from the shower water-discharge holes to remove contamination. Therefore, the showerhead can widely be used for cleaning, of articles, removing contamination, for agriculture work, fishery work and industrial work.

### BRIEF DESCRIPTION OF THE DRAWINGS

FIG. 1(a) is a plan view of a conventional showerhead as viewed from an upper water-discharge plate, FIG. 1(b) is an explanatory vertical sectional view of an interior structure of FIG. 1(a), and FIG. 1(c) is a transverse sectional view of the internal structure in FIG. 1(a);

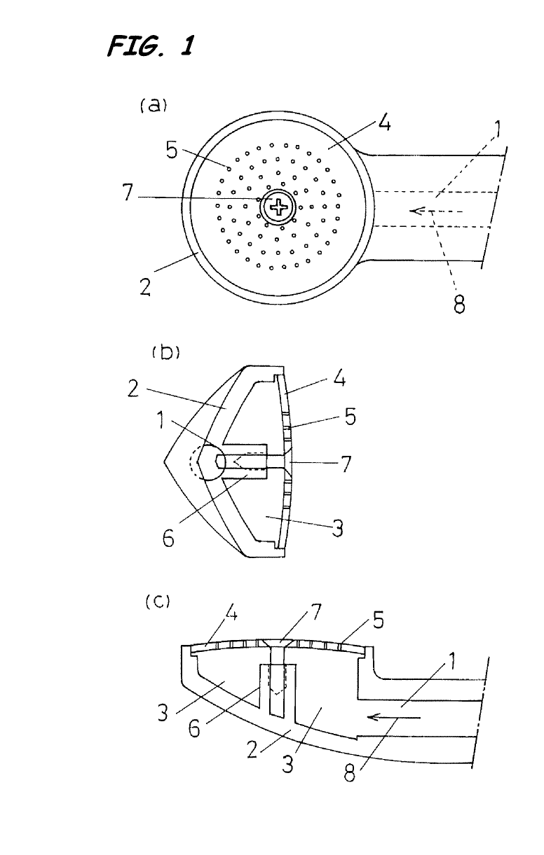

FIG. 2(a) is a plan view of a showerhead of the present invention as viewed from an upper water-discharge plate, and FIG. 2(b) is a plan view for explaining an internal structure from which the upper water-discharge plate is removed from the state shown in FIG. 2(a);

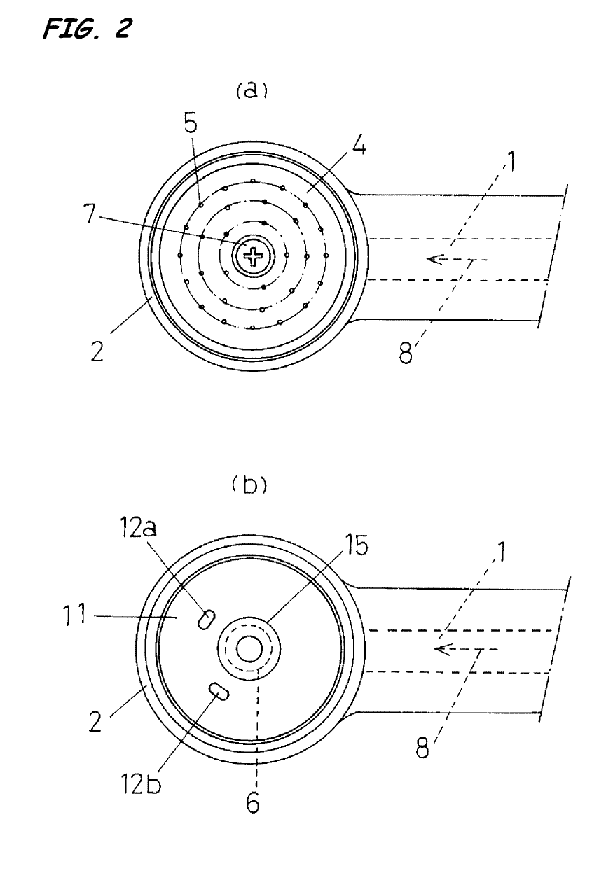

FIG. 3(a) is a partially omitted vertical sectional view for explaining the showerhead shown in FIG. 2(a), and FIG. 3(b) is a transverse sectional view of the showerhead shown in FIG. 2(a) for explaining the internal structure;

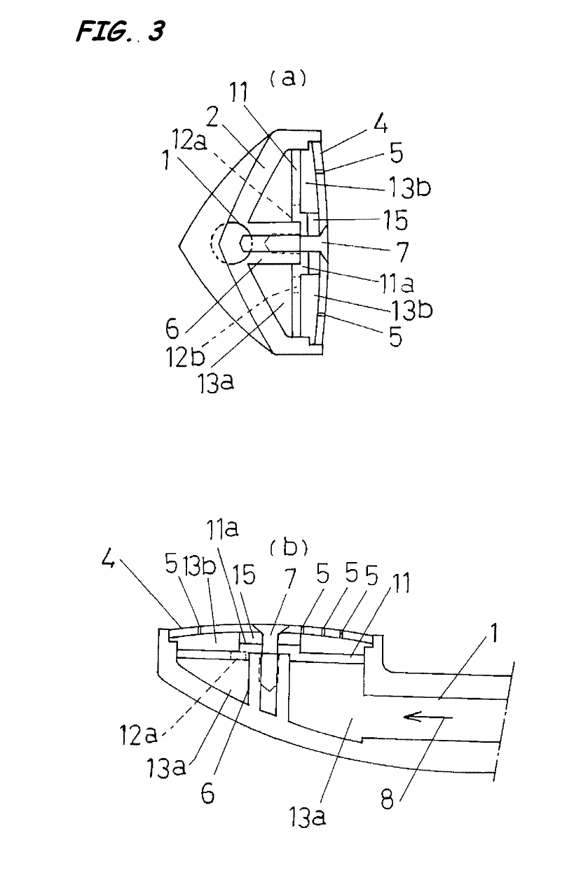

FIG. 4(a) is a vertical sectional view of the showerhead of the invention for explaining the internal structure, and FIG. 4(b) is a transverse sectional view of the showerhead of the invention for explaining the internal structure;

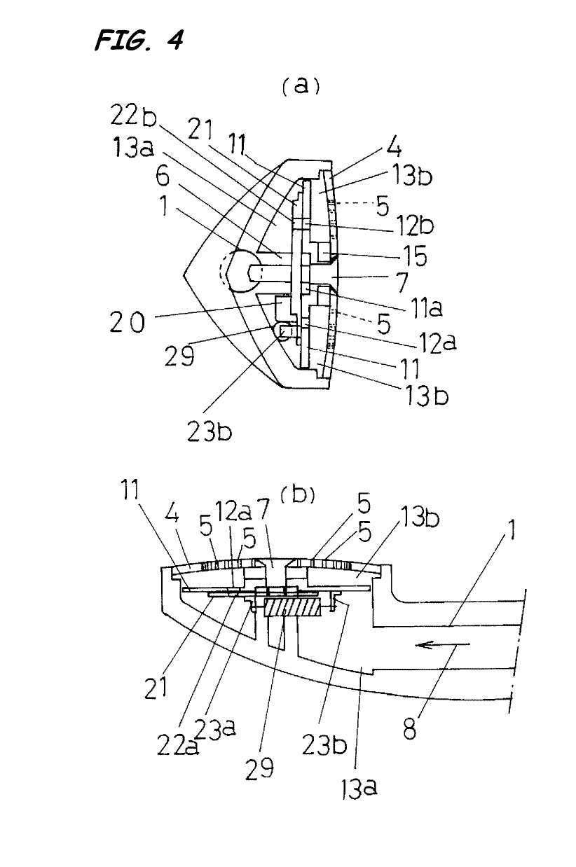

FIG. 5(a) is an explanatory diagram of the internal structure of the showerhead of the invention as viewed from the feedwater-side space, FIG. 5(b) is an explanatory diagram of a state of the showerhead of the invention where the feedwater-side space and a discharge-side space are brought into communication with each other through communication holes and adjusting holes; and FIG. 5(c) is an explanatory diagram of one example of a structure in which an adjusting plate is slidably disposed on the side of the feedwater-side space; and

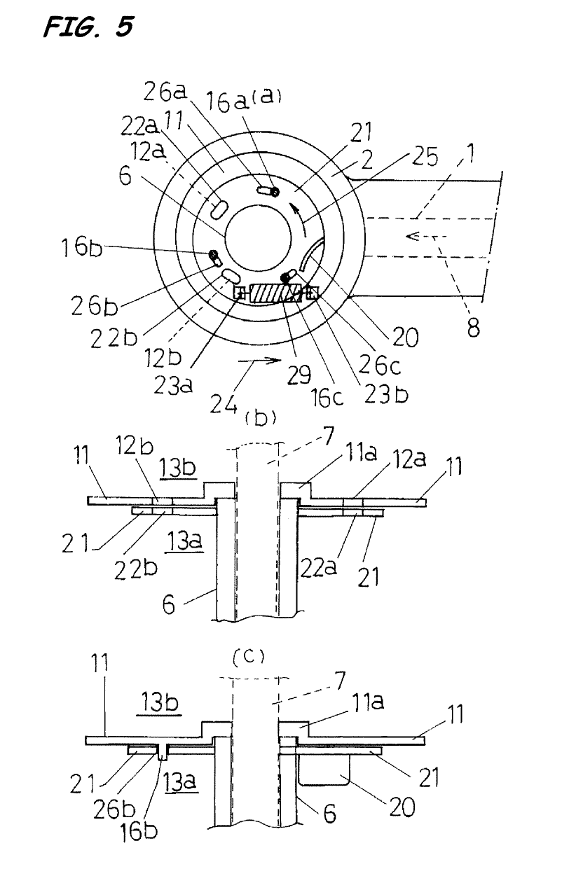

FIG. 6(a) is an explanatory diagram of a state where the adjusting plate slides and a total cross-sectional area through which clean water of the communication holes passes is reduced, and FIGS. 6(b) and 6(c) are explanatory diagram of a state where the adjusting plate slides and the total cross-sectional area through which clean water passes is adjusted.

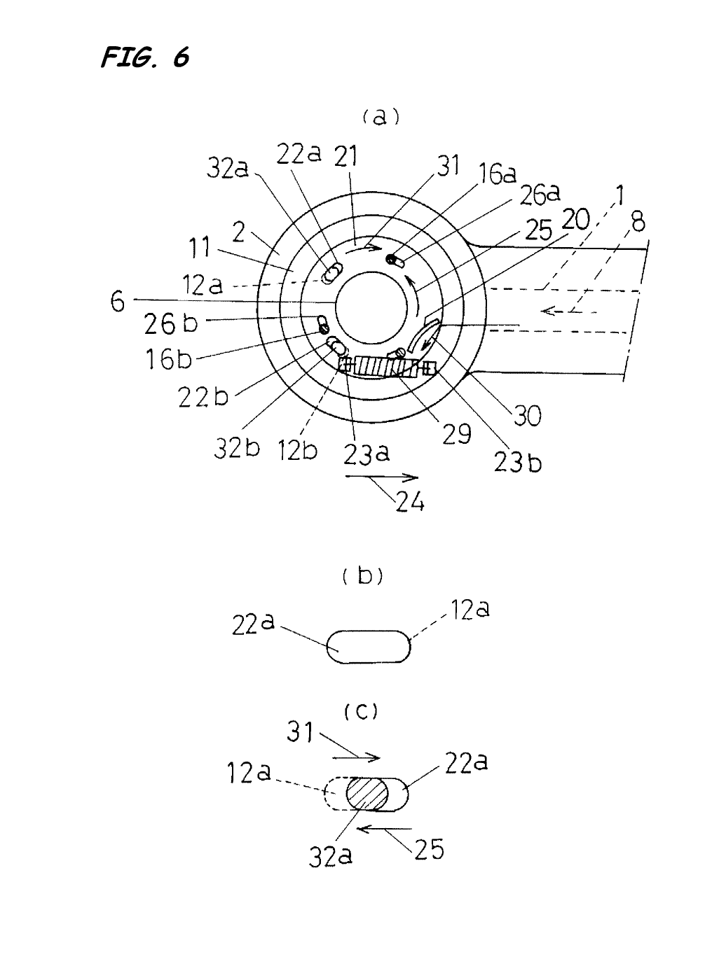

### Explanation of Symbols

1 main water port
2 head main body
3 space in head main body
4 upper water-discharge plate
5 shower water-discharge holes
11 parting plate
13b discharge-side space
13a feedwater-side space
12a, 12b communication hole
22a, 22b adjusting hole
21 adjusting plate
26a, 26b, 26c guide groove
16a, 16b, 16c guide projection
29 spring
20 water amount adjusting piece

1. A showerhead in which clean water is supplied into a space in a head main body whose upper end is closed with an upper water-discharge plate through a main water port, and the clean water is discharged through a plurality of shower water-discharge holes formed in the upper water-discharge plate, wherein
the space is divided by a parting plate having at least one or more communication holes into a feedwater-side space formed on the side of the upper water-discharge plate and a discharge-side space formed on the side of the main water port,
an adjusting plate has adjusting holes at locations corresponding to the communication holes formed in the parting plate, the adjusting plate is slidably disposed on the parting plate on the side of the feedwater-side space,
the discharge-side space and the feedwater-side space are in communication with each other through the communication holes formed in the parting plate and the adjusting holes formed in the adjusting plate at location corresponding to the communication holes of the parting plate, and
a total cross-sectional area through which the clean water passes from the feedwater-side space to the discharge-side space through the communication holes is adjusted by sliding the adjusting plate on a surface of the parting plate on the side of the feedwater-side space.

2. The showerhead according to claim 1, wherein the adjusting plate always receives a biasing force in a direction increasing or reducing the total cross-sectional area through which the clean water passes from the feedwater-side space to the discharge-side space through the communication holes,
the adjusting plate includes a water amount adjusting piece disposed in a direction intersecting with a flow of the clean water supplied to the space in the head main body through the main water port, and
the adjusting plate slides in a direction reducing or increasing the total cross-sectional area through which the clean water passes.

3. The showerhead according to claim 1, wherein a capacity of the feedwater-side space is two to three times greater than a capacity of the discharge-side space, and
when the total cross-sectional area through which the clean water of the main water port passes is defined as a total cross-sectional area of a portion from the feedwater-side space to the discharge-side space through which the clean water passes is in a range of 38 to 44, and a total cross-sectional area of the shower water-discharge holes through which the clean water passes is in a range of 12 to 16.
